(19) United States
(12) Patent Application Publication
(10) Pub. No.: US 2008/0247183 A1
(43) Pub. Date: Oct. 9, 2008

(54) BUS STOP ARM AND LAMP FOR BUS STOP ARM

(75) Inventor: Lyn Brandon BILLINGSLEY, Montgomery, TX (US)

Correspondence Address: FOLEY AND LARDNER LLP;SUITE 500, 3000 K STREET NW, WASHINGTON, DC, 20007, US

(73) Assignee: Heavy Duty Bus Parts, Inc.

(21) Appl. No.: 12/044,776

(22) Filed: Mar. 7, 2008

Related U.S. Application Data
(60) Provisional application No. 60/894,105, filed on Mar. 9, 2007.

(51) Int. Cl. B60Q 1/00; F21V 19/00; H05B 41/36; H01R 13/66; F16M 11/00

(52) U.S. Cl. 362/487; 362/382; 315/291; 439/620.02; 248/560

(57) ABSTRACT

A disclosed bus stop arm includes an extendable arm for protruding from a bus and including signage instructing motorists to stop, a socket in the extendable arm for receiving a lamp, and a lamp having a connector configured to be received in the socket. The lamp includes at least two light emitting diodes, the light emitting diodes projecting light in substantially opposite primary directions. A disclosed lamp for a bus stop arm includes a connector configured to fit in a lamp socket on a bus stop arm, and at least two light emitting diodes. The light emitting diodes project light in substantially opposite primary directions.

### CROSS-REFERENCE TO RELATED PATENT APPLICATIONS

The present application claims priority to U.S. Priority Provisional Application No. 60/894,105 filed Mar. 9, 2007, and the aforementioned application is hereby incorporated herein by reference in its entirety.

### BACKGROUND

The present application relates generally to the field of lamps. More specifically, the disclosure relates to lamps using light emitting diode (LED) technology in a stop arm for a school bus.

A school bus often will have a stop arm that extends from the side of the bus to emphasize that motorists must stop at the critical point of loading/unloading children. Existing school bus stop arms utilize incandescent, LED and strobe technologies in various ways to help eliminate the dangerous and illegal passing of the school bus during loading/unloading.

A common product utilizes incandescent lights on both the upper and lower half of the stop arm, which alternately illuminate in an upper/lower/upper/lower sequence. The alternating sequence is controlled by an onboard flasher assembly unit (a product of the bus body itself). As more and more emergency vehicles move toward rapid flash technology, motorists become de-sensitized to buses with the older steady state, incandescent lamp technology.

Strobe lamp technology uses the same upper/lower flash pattern, only with a more rapid flash pattern characteristic of strobes. This technology, however, has disadvantages. The strobe unit utilizes a power pack and flasher assembly found within the stop arm itself. Thus, to convert an existing incandescent stop arm to strobe is a costly and a time consuming task. Moreover, strobe lamp technology uses expensive Xenon bulbs, which must be replaced often.

LED bulb technology generally work in two different manners. In a first type of LED stop arm, individual LEDs actually spell out the word “STOP” and utilize the buses internal flasher to activate and deactivate the LEDs to yield an on/off pattern. In a second type of LED stop arm, the lights are rapid flash LED modules. These encapsulated units utilize multiple LEDs mounted on a PCB and are self contained along with a lens to create a “sealed module”. To convert an existing incandescent stop arm to this type of LED, a technician must remove internal components and replace existing wires, resulting in a time consuming and costly effort.

### SUMMARY

According to one embodiment of the present invention, a bus stop arm comprises an extendable arm for protruding from a bus and including signage instructing motorists to stop. The bus stop arm further comprises a socket in the extendable arm for receiving a lamp, and a lamp having a connector configured to be received in the socket. The lamp includes at least two light emitting diodes, the light emitting diodes projecting light in substantially opposite primary directions.

According to another embodiment of the present invention, a lamp for a bus stop arm comprises a connector configured to fit in a lamp socket on a bus stop arm, and at least two light emitting diodes. The light emitting diodes project light in substantially opposite primary directions.

### BRIEF DESCRIPTION OF THE DRAWINGS

The features, aspects, and advantages of the present invention will become apparent from the following description, appended claims, and the accompanying exemplary embodiments shown in the drawings, which are briefly described below.

FIG. 1 is a front view of an LED lamp according to one exemplary embodiment, coupled to an existing incandescent bulb socket in a school bus stop arm.

FIG. 2 is a side perspective view of the LED lamp of FIG. 1 removed from the incandescent bulb socket, showing the interface.

FIG. 3 is a side perspective view of the incandescent bulb socket in the school bus stop arm of FIG. 1.

FIG. 4 is a schematic diagram of the LED lamp of FIG. 1.

FIG. 5 is a more detailed schematic diagram of the LED lamp of FIG. 1.

FIG. 6 is a front view of a base of the LED lamp of FIG. 1.

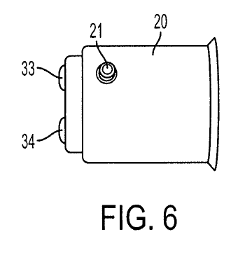

FIG. 7 is a rear view of a school bus stop arm with the LED lamp of FIG. 1 mounted to a top socket and with a lens affixed over the bottom socket, which also contains an LED lamp.

FIG. 8 is a cross-sectional view taken along line 8-8 in FIG. 1.

### DETAILED DESCRIPTION

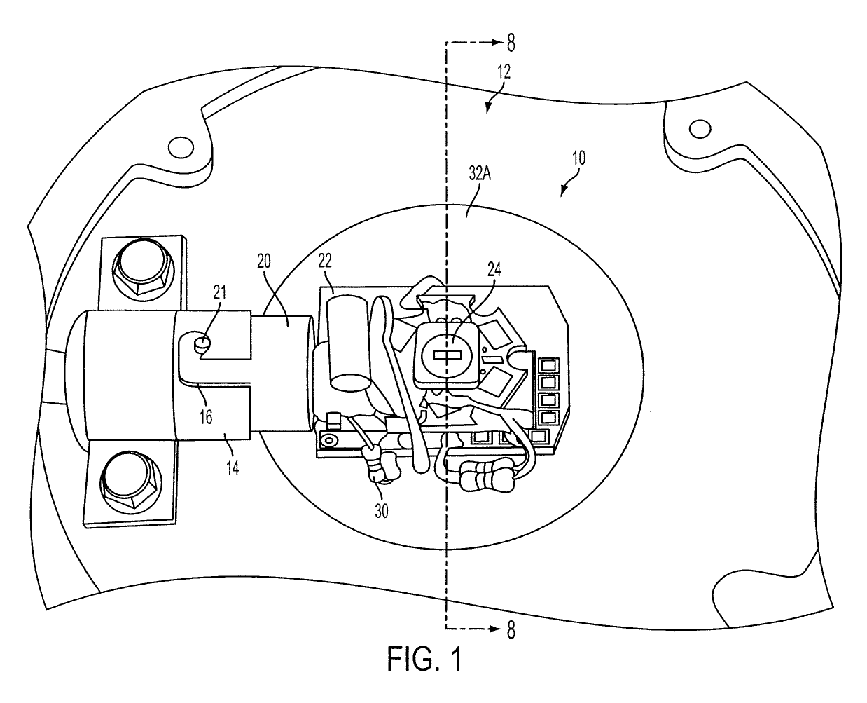

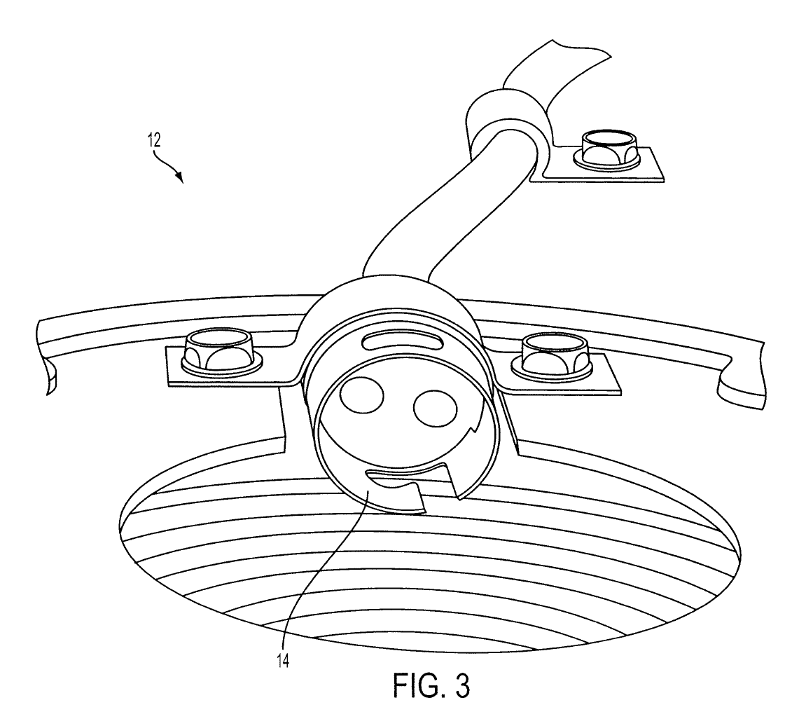

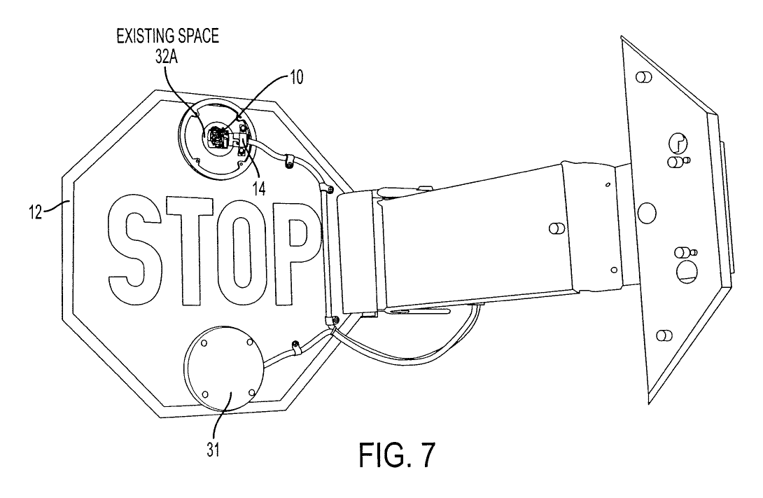

Referring to FIG. 1, an embodiment of a LED lamp 10 according to the present invention is shown. According to one preferred embodiment, the LED lamp 10 is configured to be used with a conventional stop arm 12 for a school bus, such as the stop arm 12 shown in FIG. 7. The lamp 10 can be configured to be a direct replacement for an existing incandescent bulb on the stop arm 12. The lamp 10 can be configured to mount in the same lamp socket 14 (as shown in FIG. 3) as the incandescent bulb it replaces, and to be small enough to be received by the existing space 32A in the stop arm configured for the incandescent bulb. At the top of FIG. 7, a partially transparent outer capsule or lens 31 has been removed from the stop arm 12 so that the existing space 32A can be seen. However, the lamp 10 is preferably configured so that in operation it will be covered with the lens 31, as shown at the bottom of FIG. 7.

The lamp 10 preferably includes two electrical contacts 33 and 34 on a connector or base 20, a printed circuit board (PCB) 22 connected to the base 20, circuit components 30, and two light emitting diodes (LEDs) 24 coupled to opposite sides of the PCB 22.

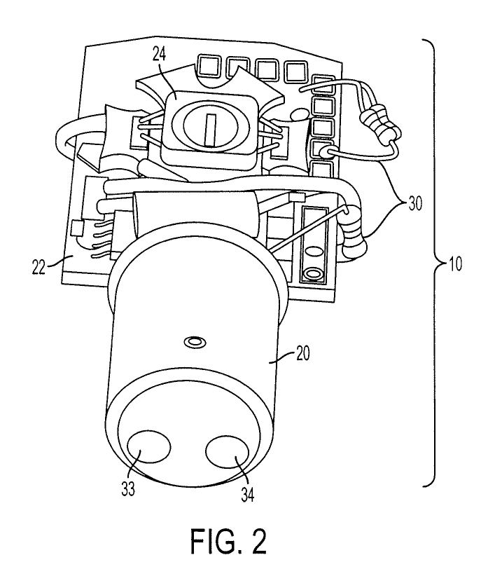

As shown in FIG. 2 and according to a preferred embodiment, the base 20 can be a two-pin bayonet connector (e.g., a SMC 1156DC (incandescent stop arm bulb)), which is a commonly used base in automotive applications. In particular, such a base is often used on incandescent bulbs mounted in school bus stop arms. The base 20 can include two outwardly extending pins 21 that extend outward from a center region of the base and engage corresponding slots 16 in the socket 14 of the school bus stop arm 12 to mechanically couple the lamp 10 to the socket 14. The interaction of the pins 21 and slots 16 also positions the lamp 10 in a proper orientation relative to the stop arm. The base 20 further includes the two electrical contacts 33 and 34. The electrical contacts 33 and 34 are provided on the bottom of the base 20 and interface with corresponding contacts within the socket 14 to electrically couple the lamp 10 to the stop arm 12. The base could, however, be other structures such as a screw base or any other lamp base that suitably physically and electrically couples the lamp to the socket. Using an existing lamp socket facilitates the retrofitting of existing incandescent systems with LED bulbs without having to add or replace other electric components.

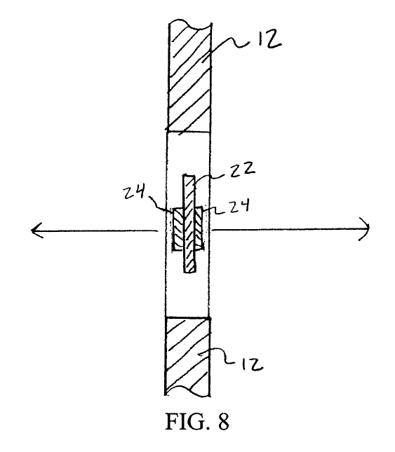

The PCB 22 preferably is physically coupled to the base 20 and electrically coupled to the electrical contacts 33 and 34. The primary plane of the PCB 22 preferably is oriented generally parallel or coincident to the primary plane of the stop arm 12 when the lamp 10 is installed in the lamp socket 14. In other words, as shown in FIG. 8, the PCB 22 and the face of the stop arm 12 preferably are oriented in the same direction. Two LEDs 24 can be coupled to the PCB 22 on opposite sides of the PCB 22 and shine light primarily outward from the PCB 22 on both sides of the stop arm 12, i.e., in the primary directions shown by the arrows in FIG. 8, though light may be emitted in other, secondary directions. By using the base 20 having the pins 21 and by creating a predetermined spatial relationship between the pins 21 and the PCB 22, the lamp 10 can be configured such that the PCB 22 and LEDs 24 will assume the desired position relative to the stop arm 12 when the lamp 10 is inserted in the lamp socket 14. In this manner, each of the two LEDs 24 can project light in a primary direction substantially perpendicular to a corresponding surface on a signage area of the stop arm 12. FIG. 7 shows one such surface of signage area on the stop arm 12, i.e., the area that states “STOP,” with a corresponding and opposing surface preferably being positioned on the other side of the stop arm 12. The LEDs 24 preferably are 1 watt to 3 watt, low heat, high intensity LEDs and are configured to accomplish the light output required to meet current photometric standards and specifications.

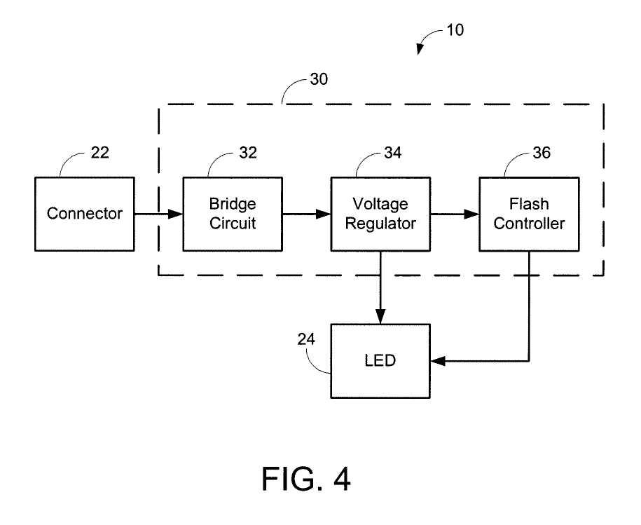

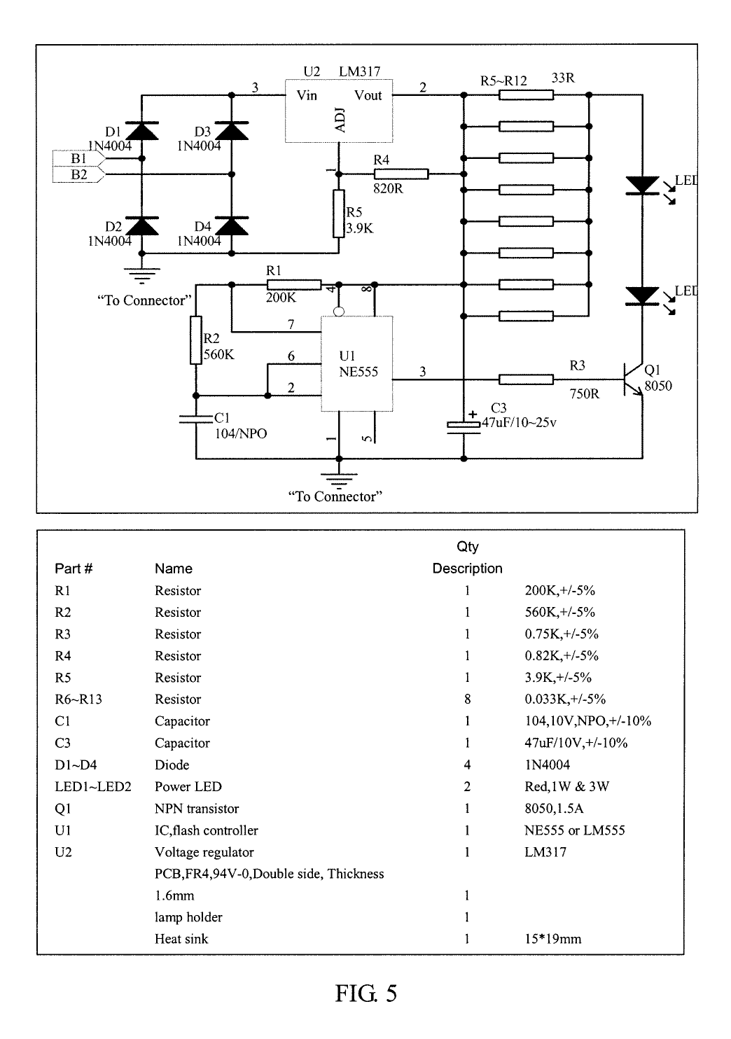

Circuit components 30 are coupled to the PCB 22 and electrically couple the LEDs 24 to the contacts 33 and 34. The circuit components 30 can be configured to regulate the voltage and current applied to the LEDs 24 and cause the flashing effect. One exemplary embodiment of the circuit components is shown in FIG. 4 and includes a bridge circuit 32, a voltage regulator 34, and a flash controller 36. FIG. 5 illustrates an embodiment of a detailed component 30 layout for the PCB 22.

The bridge circuit 32 allows for greater freedom in mounting the lamp 10 to the socket 14, as it can allow the base 20 to be connected to the socket 14 in a plurality of configurations. The socket 14 is connected to the supply of DC power. The existence of the bridge circuit 32 allows the lamp 10 to function regardless of whether the base 20 is inserted into the socket 14 either of, for example, two orientations. In either of the two orientations, the contacts 33 & 34 (DC +/−) will align with power output/input on the socket 14 and provide DC power to the lamp 10. When the lamp 10 is mounted into the socket 14, the bridge circuit adjusts for the positive/negative points on the bottom of the lamp 10 and corrects the flow of DC current. According to one exemplary embodiment the bridge circuit 32 includes four diodes D1-D4 (see FIG. 5, pt#IN4004) that will adjust the input voltage from random direction to fixed direction. This allows the lamp 10 to function correctly regardless of the orientation of the lamp 10 relative into the socket 14.

The voltage regulator 34 provides a substantially constant voltage to the LEDs 24. The voltage regulator 34, labeled as component U2 (pt#LM317) in FIG. 5, is electrically connected to the bridge circuit 32, then to the flash controller 36, and to the LEDs 24 through a series of resistors R1-R12 of differing values (see FIG. 5 component list). The voltage regulator 34 (U2) lowers the input voltage to from >12VDC to 6.2-7VDC, thereby protecting the LEDs 24 and other components 30. The resistors R1-R12 are added to restrict the current and further protect the LEDs 24 and components 30, and prevent the LED 24 brightness from being affected when input voltage changes (e.g., during voltage spikes).

The flash controller 36 can cause the LEDs 24 to generate flashing light. The flash controller 36 (FIG. 5; U1 pt#NE555) is electrically connected to the voltage regulator 34 (FIG. 5; U2) and the LEDs 24 through the resistors R1-R12, and causes and regulates the flashing effect to an output frequency of preferably 11.2 Hz/58.2% duty cycle. Thus the flash controller (FIG. 5 U1) causes the LEDs 24 to generate the rapid flash effect.

The lamp 10, according to a preferred embodiment of the invention, can be configured to fit and operate in an existing (incandescent) bulb socket on a school bus stop arm (e.g. SMC 1156DC). The LEDs 24 can be arranged on the PCB 22 in a manner so that they will fit on a conventional stop arm 12 within the existing space 32 between the lenses 31 (see FIG. 7) designed for a conventional incandescent bulb on both the top and bottom half of the school bus stop arm 12. Because the lamp 10 uses the existing incandescent bulb socket and in view of the relatively compact construction of the lamp 10, only a minimal effort is needed to substitute the lamp 10 for an existing incandescent bulb. For example, the effort required could be no more than is needed to replace a conventional incandescent bulb.

Additionally, the lamp 10 can be configured to emit light in a rapid flash pattern, without requiring modification of the existing school bus stop arm 12. By emitting light in a rapid flash manner and meeting all pertaining federal specifications the stop arm will benefit with the gain of the strobe like effect of using rapid flash technology, grabbing added motorist attention. These benefits are the same as those employed through rapid flash light technology commonly found on many of today's emergency vehicles.

The lamp can be configured to include all the benefits of LED technology including efficiency, lower power consumption, and product longevity, with rapid flash technology to attract more motorist attention. The lamp can be configured to use existing incandescent sockets to avoid the costly retrofitting that is needed with currently known products. The ease of a ‘plug and play’ product such as described in this disclosure will be made more cost effective through the combination low LED count/low cost solution with the decreased amount of time needed to convert the stop arm. The intent is that school bus safety is allowed to be enhanced through more widespread use of (advanced warning) lighting.

Given the various embodiments disclosed above and shown in the figures, it is contemplated that various aspects of the different embodiments may be transferable to other embodiments; thus the features of each embodiment is transferable to other embodiments.

With the above-disclosure, various embodiments of the LED stop arm lamp are disclosed. Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. A bus stop arm, comprising:
an extendable arm for protruding from a bus and including signage instructing motorists to stop;
a socket in the extendable arm for receiving a lamp; and
a lamp having a connector configured to be received in the socket, wherein the lamp includes at least two light emitting diodes, the light emitting diodes projecting light in substantially opposite primary directions.

2. The bus stop arm of claim 1, wherein the socket includes a bayonet socket and the connector includes a bayonet connector configured to be received in the bayonet socket.

3. The bus stop arm of claim 1, wherein the signage includes two opposing surfaces and each of the at least two light emitting diodes projects light in a primary direction substantially perpendicular to a corresponding one of the surfaces.

4. The bus stop arm of claim 1, wherein the lamp includes a printed circuit board connected to the connector, and the at least two light emitting diodes are mounted on opposite sides of the printed circuit board.

5. The bus stop arm of claim 1, wherein the lamp includes a bridge circuit that allows the connector to be connected to the socket in a plurality of configurations.

6. The bus stop arm of claim 1, wherein the lamp includes a voltage regulator that provides a substantially constant voltage to the light emitting diodes.

7. The bus stop arm of claim 1, wherein the lamp includes a flash controller that causes the light emitting diodes to produce flashing light.

8. A lamp for a bus stop arm, the lamp comprising:
a connector configured to fit in a lamp socket on a bus stop arm; and
at least two light emitting diodes, the light emitting diodes projecting light in substantially opposite primary directions.

9. The lamp of claim 8, wherein the connector includes a bayonet connector configured to be received in a bayonet lamp socket on a bus stop arm.

10. The lamp of claim 9, wherein the light emitting diodes are disposed in a spatial relationship to the bayonet connector such that a predetermined orientation of the light emitting diodes is achieved when the bayonet connector is disposed in a bayonet lamp socket.

11. The lamp of claim 8, comprising a printed circuit board connected to the connector, wherein the at least two light emitting diodes are mounted on opposite sides of the printed circuit board.

12. The lamp of claim 8, comprising a bridge circuit that allows the connector to be connected to the lamp socket in a plurality of configurations.

13. The lamp of claim 8, comprising a voltage regulator that provides a substantially constant voltage to the light emitting diodes.

14. The lamp of claim 8, comprising a flash controller that causes the light emitting diodes to produce flashing light.
